(19) United States
(12) Patent Application Publication
(10) Pub. No.: US 2023/0256430 A1
(43) Pub. Date: Aug. 17, 2023

(54) MICROFLUIDIC PRESSURE IN PAPER (µPIP) FOR ULTRA LOW-COST PRECISION MICRO TOTAL ANALYSIS SYSTEMS

(71) Applicant: The Texas A&M University System, College Station, TX (US)

(72) Inventors: Zachary Richard Gagnon, College Station, TX (US); Md Nazibul Islam, College Station, TX (US)

(21) Appl. No.: 17/920,929

(22) PCT Filed: Apr. 28, 2021
(86) PCT No.: PCT/US2021/029556

§ 371 Date: Oct. 24, 2022

Related U.S. Application Data
(60) Provisional application No. 63/016,676, filed on Apr. 28, 2020.

(51) Int. Cl. B01L 3/00

(52) U.S. Cl. CPC B01L 3/502707; B01L 3/50273; B01L 2200/0694; B01L 2300/0645; B01L 2300/0867; B01L 2300/0883; B01L 2300/0887; B01L 2300/126; B01L 2400/0406

(57) ABSTRACT

A method for producing a microfluidic device includes creating a paper channel using a cutting device (e.g., a laser cutter, scissors, dies, blade, or the like), placing the paper channel between two sheets of PDMS, treating the PDMS sheets with a corona plasma to adhere the PDMS sheets together, and using heat to laminate the microfluidic device.

### CROSS-REFERENCE TO RELATED APPLICATIONS

This application claims priority to, and incorporates by reference the entire disclosure of, U.S. Provisional Patent Application No. 63/016,676, filed on Apr. 28, 2020.

### STATEMENT REGARDING FEDERALLY SPONSORED RESEARCH OR DEVELOPMENT

This invention was made with government support under Grant No. 80NSSC19K1401 awarded by The National Aeronautics and Space Administration. The government has certain rights in the invention.

### TECHNICAL FIELD

The present disclosure relates generally to Microfluidic Pressure in Paper (μPiP) and more particularly, but not by way of limitation, to uPiP configurations and methods.

### BACKGROUND OF THE INVENTION

This section provides background information to facilitate a better understanding of the various aspects of the disclosure. It should be understood that the statements in this section of this document are to be read in this light, and not as admissions of prior art.

PDMS (Polydimethylsiloxane) and paper-based microfluidics are promising avenues for micro total analysis systems development. However, market penetration of microfluidic devices remains very low due to the lack of rapid, low-cost and scalable fabrication techniques.

In recent times, microfluidics has received widespread attention from both academia and industry due to its ability to develop robust and portable micro total analysis systems (μTAS, or lab-on-a-chip). The global microfluidics market size is expected to reach 31.6 billion USD by 2027. Over the past few decades, researchers have reported thousands of novel microfluidic platforms in the fields of environmental, pharmaceutical and biomedical engineering. However, very few of them have translated into commercial products. The disconnect between device developers and end users and also the absence of low cost, precise, and high throughput manufacturing techniques have been reported as principle causes for low market penetration of microfluidic devices.

In academia, soft lithography has been the predominant choice of fabrication technique for microfluidic devices. Soft lithography techniques use photolithography to create master molds on a silicon wafer. A pre-polymer (mostly PDMS) is poured on top of this master mold. When cured, this PDMS containing replica of the master mold is peeled off and bonded irreversibly to a glass slide using plasma treatment. An advantage of soft lithography is the ability to create submicron features with high resolution. In addition, gas permeability and biocompatibility of PDMS makes it an ideal choice for biomedical microfluidic devices. However, lack of scalability and requirement of a cleanroom facility to create submicron features have limited the use of soft-lithography in industrial settings. For industrial manufacturing, injection molding and hot embossing have been used extensively to fabricate commercial microfluidic devices. In contrast to soft lithography, these techniques have higher throughput and can fabricate thousands of devices in a relatively short amount of time. However, these techniques require high entry cost due to expensive manufacturing devices and are restricted to thermoplastics for device fabrication.

Over the past decade, paper-based microfluidics have gained widespread attention as a novel method for creating microfluidic devices for use in low-resource settings. Paper is hydrophilic in nature and different techniques such as, photolithography, plasma oxidation, cutting, and wax printing can be used to create and pattern hydrophobic zones within a paper matrix to create no-flux liquid boundaries and direct microfluidic flows. Fluid transport typically takes place passively within the porous paper structure via capillary action, and paper-based microfluidics has been used extensively for lateral flow assays and colorimetric detection devices. However, a lack of active fluid control and variability in fluid transport due to evaporation is a major limitation for paper-based microfluidic devices. Such a lack in reproducibility and controllability in real-world environmental conditions have limited paper-based microfluidics from successfully competing with PDMS and injection molded technologies.

Therefore, there is a need for a rapid fabrication technique that combines PDMS and paper. Devices fabricated by the inventive technique are low-cost, scalable, robust, reproducible and can be used for multiple applications. In addition, the digital nature of this technique allows it to be shared, edited and used by multiple stakeholders.

### SUMMARY OF THE INVENTION

A novel methodology for fabricating paper based fluidic devices for environmental and health monitoring is disclosed. A technique for encapsulating paper channels inside PDMS membranes is described herein. Surfaces of the PDMS membranes are modified using a corona plasma treatment, paper channels are placed in between the PDMS membranes, and high temperature and pressure are applied to the paper channel-PDMS layers to encapsulate the paper channel in between PDMS membranes. This technique eliminates air pockets between the paper channel-PDMS interface, and can produce multilayered fluidic channels with micrometer resolution. A pressure system has been developed to flow fluids through fluidic channels. This method can be used to purify fluids, monitor target analyte concentration in fluids, and perform ex vivo cell monitoring.

An embodiment of the invention is directed to a method for producing a microfluidic device for handling a liquid, the method comprising: creating paper channels using a cutting device (e.g., a laser cutter, scissors, dies, blade, or the like); placing the paper channels between two sheets of PDMS; treating the PDMS sheets with a corona plasma to adhere the PDMS sheets together; and using heat to laminate the device.

Another embodiment of the invention is directed to a microfluidic device made by creating paper channels using a cutting device (e.g., a laser cutter, scissors, dies, blade, or the like); placing the paper channels between two sheets of PDMS; using heat to laminate the device, wherein the PDMS sheets have been treated with a corona plasma treater to adhere the PDMS sheets together.

### BRIEF DESCRIPTION OF THE DRAWINGS

The disclosure is best understood from the following detailed description when read with the accompanying figures. It is emphasized that, in accordance with standard practice in the industry, various features are not drawn to scale. In fact, the dimensions of various features may be arbitrarily increased or reduced for clarity of discussion.

FIGS. 1A, 1B, 1C and 1D illustrate a method of fabrication of μPiP device, according to aspects of the disclosure;

FIG. 2 is a graph of length (mm) versus time (sec) comparing different applied pressures for theoretical and experimental studies of a μPiP device;

FIGS. 3A, 3B, 3C and 3D illustrate different configurations of μPiP devices, according to aspects of the disclosure;

FIG. 4 illustrates a system for using dielectrophoresis with a μPiP device, according to aspects of the disclosure;

FIGS. 5A, 5B, 5C and 5D illustrate a method of fabrication of a μPiP device, according to aspects of the disclosure;

FIG. 6A illustrates the μPiP device of FIGS. 5A-5D in use, according to aspects of the disclosure;

FIG. 6B is a collection of graphs illustrating normalized gray value (I*) versus normalized axial length (X*) at 0V, 100V, 200V, and 300V;

FIG. 7 is a graph of RFU versus cycle for a qPCR analysis;

FIGS. 8A and 8B illustrate conductivity (μS/cm) versus time (sec) (FIG. 8A) and length (mm) versus time (sec) for a μPiP device (FIG. 8B);

FIG. 9 is a graph of deformation versus cell area; and

FIG. 10 is a graph of distance versus time illustrating wetting length for various animal blood types.

### DETAILED DESCRIPTION OF EXEMPLARY EMBODIMENTS

Various embodiments will now be described more fully with reference to the accompanying drawings. The disclosure may, however, be embodied in many different forms and should not be construed as limited to the embodiments set forth herein.

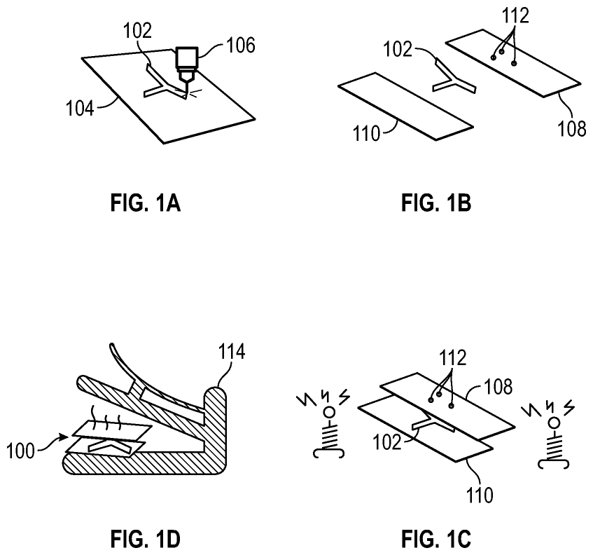

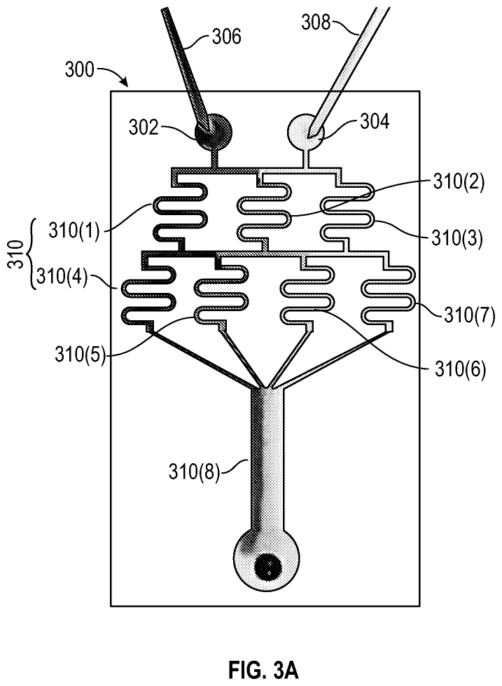

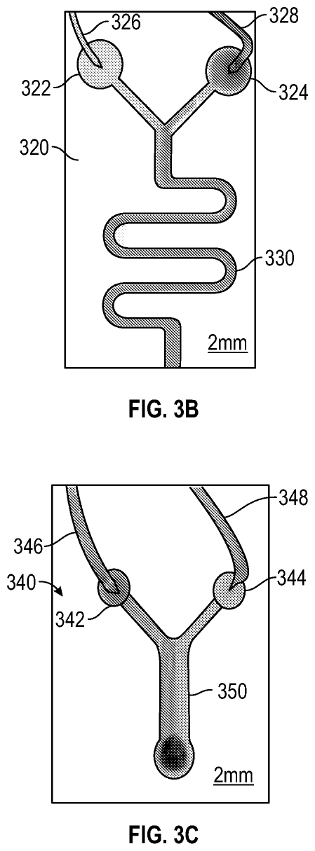

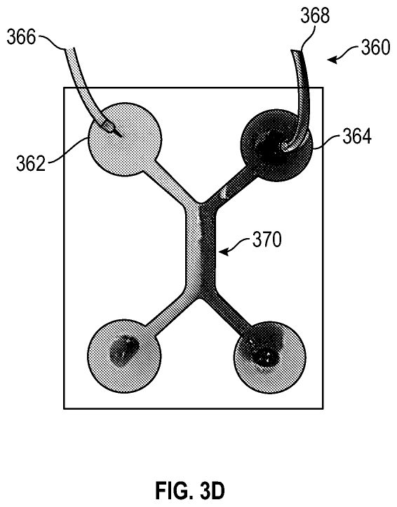

An embodiment of the invention is directed to a method for the fabrication of microfluidic pressure in paper (μPiP) device. FIGS. 1A-1D illustrate a method of fabricating a μPiP 100. The laminated nature of this approach enables the paper channels to support an external pressure to control the on-PIP fluid flow in a manner similar to that of conventional microfluidic channels. A first step (FIG. 1A) in fabricating μPiP 100 is to cut paper channels 102 from paper 104 (e.g., Whatman Grade 1 paper) into the desired configuration. As shown in FIGS. 1A-1D, paper channels 102 are cut into a Y shape. In other aspects, other configurations can be cut (e.g., see FIGS. 3A-3D). Cutting paper channels 102 can be done using a variety of cutting devices, such as a laser cutter 106 (e.g., a CO₂ laser cutter PLS6.120D from Universal Laser System, Inc.). The laser cutter can precisely and rapidly cut hundreds of paper channels with a dimension as small as 100 μm across large area (˜1 m²) sheets of paper. However, for applications where micron level precision is not required (such as 4 to 5 mm wide paper channels), other cutting devices can be used to cut the desired configuration from paper sheets (e.g., scissors, cutting blades, dies, and the like).

FIG. 1B illustrates a second step in which paper channels 102 are placed between two PDMS sheets 108, 110. Depending upon the desired stiffness of the end product, PDMS sheets 108, 110 can have different thickness. For work presented here, channels were laminated between a 0.5 mm PDMS sheet (0.02 inch, McMaster-Carr) as a “top” layer and a 0.12 mm PDMS sheet (0.005 inch, McMaster-Carr) as the “bottom” layer Channel inlets/outlets 112 are punched through the top layer using a punch (biopsy punch from Ted Pella, Inc.) One advantage of μPiP over traditional microfluidic devices is that μPiP is much more robust than glass-PDMS microfluidic devices, which can break/fracture more easily. μPiP devices made from PDMS sheets and paper can easily deform without breaking the seal and still flow fluid. Therefore, these devices can be handled with less care and survive more intense situations and environments, such as space launches and can be used in space.

FIG. 1C illustrates a third step in which a corona treatment is applied on the PDMS sheets 108, 110 to oxidize and irreversibly bond the PDMS sheets to each other using oxygen plasma generated with a handheld tesla coil (Electro-Technic Products, Model BD-20AC). FIG. 1D illustrates a fourth step in which a heat press 114 (3-Ton Dulytek DW 400) is used to press the PDMS sheets 108, 110 at 95° C. for 5 min Depending on various parameters, such as the thickness of the PDMS sheets, the temperature of and time for the heat press may be adjusted. Tubing was then inserted into the fluidic inlet and outlet ports 112 of PDMS sheet 108 and a constant pressure system was used to flow fluid through paper channels 102. Pressure driven fluid flow through the resulting μPiP channels can be actively regulated through the modulation of an applied external pressure to a fluidic channel inlet or outlet port. PDMS sheets 108, 110 are air permeable, which permits any air bubble present during the fabrication steps to leak out.

A μPiP sealing technique has also been developed using water soluble paper. This technique is similar to the one discussed in reference to FIGS. 1A-1D, but water soluble paper (SmartSolve Industries) is used to fabricate paper channels. In this technique a sheet of water-soluble paper is used as a sacrificial μPiP channel. After lamination in PDMS, the paper dissolves from the laminated area leaving an open-ended channel in the shape of the laser cut paper geometry. This technique can be used to fabricate PDMS-style fluidic channels in millimeter range without a cleanroom.

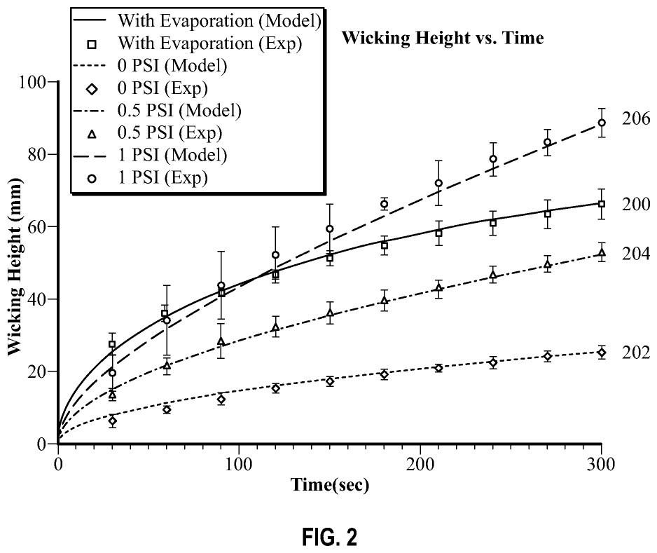

FIG. 2 is a graph of wicking height (mm) versus time (sec) comparing different applied pressures for theoretical and experimental studies. Traditional paper flow depends upon the wicking of fluid through paper channels. Flow is calculated using Washburn's equation for capillary flow. For μPiP, in addition to Washburn's equation, Darcy's law for porous flow comes into effect:

$${h}_{o} = \sqrt{\frac{4 σ cos ( θ )}{μ} \frac{K}{ϵ R}} \cdot {t}^{1 / 2} + \frac{K Δ P}{μ L} \cdot t \qquad Equation 1$$

$$K = {r}^{2} \frac{π ϵ ( 1 - {\sqrt{1 - ϵ )}}^{2}}{24 {( 1 - ε )}^{1.5}} \qquad Equation 2$$

$${h}_{ev} = 2 N \cdot {e}^{- M t} {\int }_{0}^{\sqrt{t}} {e}^{M {t}^{2} dt} \qquad Equation 3$$

$$Where$$

$$N = \sqrt{\frac{σ cos ( θ )}{μ} \frac{K}{ϵ R}} \qquad Equation 4$$

$$and$$

$$M = \frac{2 {m}_{e v}^{*}}{ρ ε δ} \qquad Equation 5$$

$${h}_{o} = \sqrt{\frac{4 σ cos ( θ )}{μ} \frac{K}{e R}} \cdot {t}^{1 / 2} \qquad Equation 6$$

where the first term in Equation 1 captures the influence of capillary wetting and the second term is the contribution to flow via an applied pressure gradient (ΔP) over a channel length, L for a given time, t. N is a modified version of Lucas-Washburn equation based on a momentum balance between capillary pressure and viscous stress. hₒ, σ, θ, μ, ∈, R, and t are the theoretical wicking liquid front height, interfacial tension, viscosity, contact angle, permeability, effective pore size, paper pore radius, and time, respectively. The second term, M indicates total evaporation mass. m*ev, ρ and δ are evaporation rate, density and paper strip thickness respectively. This term is used in Equation 3 to determine the effect of evaporation on wicking height over a time period of t. Because paper channels in μPiP are enclosed in two PDMS membranes, fluid transport by evaporation through PDMS was calculated to be only 1.03% of the rate of evaporation at experimental laboratory conditions (25° C., 35% Relative Humidity). Therefore, we neglected the influence of evaporation and fluid flow in a pressurized μPiP channel was assumed to be driven through a linear combination of capillary wetting and transport in a porous media by a pressure gradient. Combining Darcy's Law with the Lucas-Washburn equation, and neglecting evaporation, the theoretical μPiP liquid penetration height (hₒ) as a function of time, t is given in Equation 1 above. To evaluate the proposed model with experimental data, available physical parameters of water and Whatman #1 filter paper were used (interfacial tension:727.1×10⁻⁴ N/m, contact angle: 80°, viscosity: 9.6075×10⁻⁴ Pa·sec, density: 997.05 kg/m3, paper thickness: 0.18 mm and, mean fiber radius: 0.0082). Permeability of paper, K for a given pore size, r, was calculated using Equation 2.

As shown in FIG. 2, the experimental values are in good agreement with the theoretical model. Blue dye (Methylene blue, 5 wt %) was flown through paper channels (Whatman #1, 2 mm wide and 100 mm long) and liquid front was monitored using a camera. ImageJ software was then used to calculate the change in fluid front with time. Wicking height was tracked in μPiP channels fabricated from Whatman #1 filter laser cut into strips 2 mm in width and 100 mm in length. The liquid penetration height for a given pressure drop was measured and then compared to the conventional passively driven non-laminated microfluidic equivalent. Flow was characterized using deionized water labelled with 5% w/v methylene blue (Sigma Aldrich). Under the application of a continuous and fixed externally applied pressure, liquid transport was observed as a moving liquid front advancing down the length of the paper channel. The resulting length of this front was then dynamically measured for different inlet pressures: 0.0 psi (e.g. pure capillary wetting), 0.5 psig, and 1.0 psig. During the flow experiments, high-resolution images were captured every 30 seconds for a period of 300 seconds using a high resolution DSLR camera.

For pure capillary flow in an open channel (i.e., non-laminated), the effective porosity was calculated using Equation 3 and determined to be E=0.65, which is in agreement with previously published data for Whatman #1 filter paper. The paper channels were then encapsulated in PDMS sheets according to the μPiP fabrication workflow and the fluid flow experiment was repeated at a pressure of 0.0 psig. As shown in FIG. 2, the rate of the moving front in encapsulated channels is reduced approximately 62% when compared to open channels. From Equation 3, the effective porosity of the laminated μPiP channel was calculated to be 0.25. Therefore, we speculate that the heat press and subsequent hydraulic encapsulation of the paper channels in PDMS sheets likely results in a decreased effective porosity of paper channels and results in a decreased flow. Only the effective porosity (e) of paper channels was varied to fit the mathematical model with the experimental data. Effective porosity takes into account blocked pores and variation in porosity and cross sectional area due to wetting. For capillary flow (see 200 in FIG. 2), the effective porosity was found to be 0.65, which is in accordance with published data. The paper channels were then encapsulated in PDMS sheets and fluid flow without external pressure was monitored. Fluid flowrate in encapsulated channels decreased as compared to open channels. When fitted with the model, the effective porosity was calculated to be 0.25 (see 202 in FIG. 2). Heat pressing and subsequent encapsulation of paper channels in PDMS sheets decreased effective porosity of paper channels, thus resulting in a decreased flow rate. Next, fluid flow for two different external pressures (0.5 psi, see 204 in FIG. 2, and 1 psi, see 206 in FIG. 2) was examined. As shown in FIG. 2, with the increase in pressure there is an increase in flowrate. This corresponded to an increase in effective porosity, with values of 0.44 and 0.53 for 0.5 psi and 1 psi, respectively. In addition, unlike capillary flow, pressurized fluid flowrate remains constant (constant slope). As described later, this phenomenon can be utilized to design complex μPiP devices that can sustain constant flowrate and create concentration gradient within a paper channel.

The influence of a pressure gradient on the liquid wetting length for two different non-zero inlet pressures was also investigated: 0.5 psig and 1.0 psig, and an outlet pressure vented to atmosphere (0.0 psig). There was an observed increase rate of wicking height with applied pressure. Further, unlike the two purely capillary flow experiments in which the observed liquid velocity decreases with increasing transport time, the pressurized fluid velocity (wicking height length per unit time) remains approximately constant (constant slope) with transport time over the period of 300 seconds.

### Applications of μPiP

μPiP devices can be used in a variety of applications, such as monitoring health and environmental indicators in biofluids and in water, DNA sample preparation and processing, and can be used to develop commercial products for fluid purification and ex vivo cell monitoring. Some exemplary applications are discussed below.

The ability to drive a continuous flow in μPiP channels using external pressure can be exploited to drive a continuous flow in more complex fluidic channel geometries, and for precise control of their subsequent liquid handling. FIGS. 3A-3D illustrate various configurations of μPiP devices for pressure-driven flows. The μPiP devices of FIGS. 3A-3D may be made by the method discussed above relative to FIGS. 1A-1D. For each device, the fluidic flow field was imaged using deionized water labelled with colored dye, driven continuously into each device at an external pressure of 1.0 psig. FIG. 3A illustrates a Whiteside's microfluidic “Christmas tree” gradient generator 300 (a constant concentration gradient produced using continuous flow on a paper device). This functionality supports that μPiP can be utilized as a simple and low-cost alternative to complex microfluidic devices for chemotaxis and pharmaceutical drug performance analysis. Microfluidic pressure in paper (μPiP) was also used to fabricate and successfully drive other microfluidic channel geometries, including a serpentine mixer 320 (FIG. 3B), a Y-channel mixer 340 (FIG. 3C), and an H-filter 360 (FIG. 3D).

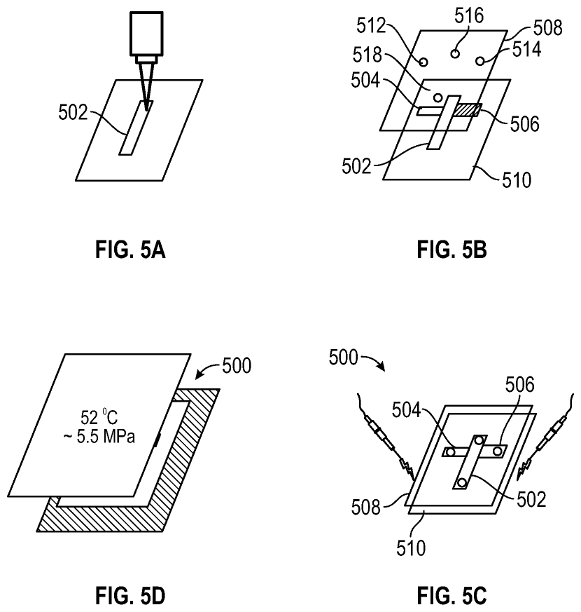

FIG. 3A illustrates gradient generator 300. Gradient generators are used to generate a chemical gradient in a fluidic channel. In pharmaceutical industries, gradient generators are used to examine how a particular dose of medicine will behave at different chemical concentrations. In addition, in biological and environmental sciences, gradient generators are used to examine how microorganisms behave under different chemical concentrations. A microorganism such as an amoeba is introduced into the gradient channel and migration of this amoeba can be monitored to see if it has any preference for any particular chemical concentration. Gradient generator 300 includes inlets 302, 304 for receiving a first fluid 306 and a second fluid 308. Inlets 302, 304 communicate first and second fluids 306, 308 to paper channel 310. As shown in FIG. 5, inlets 302, 304 lead to a header 312(1) that further communicates the fluids to channels 310(1)-310(3) Channels 310(1)-310(3) lead to a header 312(2), which in turn leads to channels 310(4)-310(7). Each of channels 310(4)-310(7) joins to a channel 310(8). Each of channels 310(1)-(7) includes at least a portion having a serpentine shape. As first and second fluids 306, 308 flow through paper channel 310, the fluids may diffuse into one another in headers 312(1), 312(2) and channel 310(8).

FIG. 3B illustrates serpentine mixer 320. Serpentine mixers may be used to perform continuous liquid mixing or dilution in a confined space. Serpentine mixer 320 includes inlets 322, 324 for receiving a first fluid 326 and a second fluid 328. First and second fluids 326, 328 flow from inlets 322, 324 into serpentine channel 330, where they may diffuse into one another.

FIG. 3C illustrates Y-channel mixer 340. Y-channel mixers may be used to combine two or more liquid streams. Y-channel mixer 340 includes inlets 342, 344 for receiving a first fluid 346 and a second fluid 348. First and second fluids 346, 348 flow from inlets 342, 344 into serpentine channel 350, where they may diffuse into one another.

H-filter 360 (FIG. 3D) may be used to purify analytes from fluidic samples. H-filter 360 includes inlets 362, 364 for receiving a first fluid 366 and a second fluid 368. In some aspects, first fluid 366 contains a target analyte and second fluid 368 contains a buffer solution. First and second fluids 366, 368 are administered to H-filter 360 via inlets 362, 364 and flown side by side. If the target analyte of first fluid 366 has a diffusivity higher than other agents, then the target analyte will diffuse into the buffer solution of second fluid 368. Therefore, the target analyte (such as biomolecules) can be purified from biofluids such as blood, sweat, saliva etc.

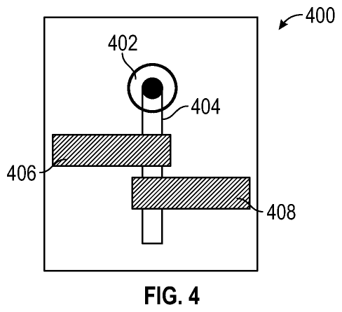

Electrodes can be integrated into μPiP devices to fabricate electrochemistry-based sensing devices. For example, FIG. 4 illustrates a μPiP device 400 with an inlet 402 formed through a top layer of PDMS, integrated electrodes 406, 408, and a paper channel 404. An AC current is applied to one of the electrodes and the other electrode is grounded. An AC electric field is dropped across electrodes 406, 408 and red blood cells are flown though paper channel 404. Two different frequencies, 500 KHz and 10 MHz were applied at the electrodes and outlet cell concentrations were measured. At 500 KHz, cell numbers measured 4×10⁶ and at 10 MHz, cell numbers measured 19.5×10⁶. It has been observed using traditional dielectrophoretic technique that red blood cells migrate toward the electrodes at frequencies between 100 KHz and 7.8 MHz and migrate at the opposite direction in all other frequencies. The outlet cell concentration was much lower at 500 KHz compared to 10 MHz. This indicates that at 500 KHz the red blood cells were trapped by the electrodes. Therefore, μPiP can be used to test biological samples for further analysis. In addition, other electrochemistry techniques such as cyclic voltammetry, potentiometry, impedance analysis etc. can be performed using μPiP.

μPiP can also be used with more complex biofluids such as blood and crude oil. For these flow experiments we used μPiP fabrication with larger pore glass paper (Ahlstrom-Munksjo grade 1667 lateral flow paper), which is designed for blood plasma separation as it possesses a large 30 μm pore size to allow red blood cells to flow. A suspension of bovine red blood cells (10% v/v in PBS solution, Quad Five) was driven through this paper channel for 10 min at an inlet pressure of 1.0 psi. Crude oil was also successfully driven through the paper with this style of channel, further demonstrating the potential versatility and robustness of this simple pressurized paper platform.

DNA Sample Preparation

An embodiment of the invention is directed to a method for the fabrication of a μPiP device for DNA sample preparation and processing that reduces the number of sample preparation steps and improves sensitivity of the quantitative polymerase chain reaction (qPCR) by electrophoretically separating and concentrating nucleic acids (NAs) continuously on paper. FIGS. 5A-5D illustrate a method of fabricating a μPiP device 500 for DNA sample preparation and processing. μPiP device 500 has immediate applications in disease diagnostics, microbial contamination, and public health monitoring. μPiP device 500 combines copper tape electrodes with paper channels to develop an electrokinetically-assisted μPiP device that can separate and concentrate charged analytes, such as DNA, from a bulk solution.

In a first step, two different paper channels 502, 504 were prepared using a laser cutter. Paper channel 502 has a pore size of 25 μm (Whatman #4, 25 μm) for bulk fluid transport and paper channel 504 has a smaller pore size of 11 μm (Whatman #1, 11 μm) for sample concentration. In a second step, paper channels 502, 504 were arranged in a cross shape (FIG. 5B) and an electrode 506 (McMaster Carr copper tape) was positioned over a portion of paper channel 504 as shown. Similar to the μPiP devices discussed above, paper channels 502, 504 were sandwiched between PDMS sheets 508, 510. Top sheet 508 includes ports 512, 514, 516, and 518. A laser cutter (PLS6.120D, Universal Laser Systems) was used to cut 3 mm wide paper channels 502, 504. Paper channels 502, 504 and electrode 506 were aligned and sealed within PDMS sheets 508, 510 (McMaster Carr) using a corona treatment (BD-20AC, Electro-Technic Products)(FIG. 5C) and a heat press (Dulytek DW 400, 52° C., max pressure ˜5.5 MPa)(FIG. 5D).

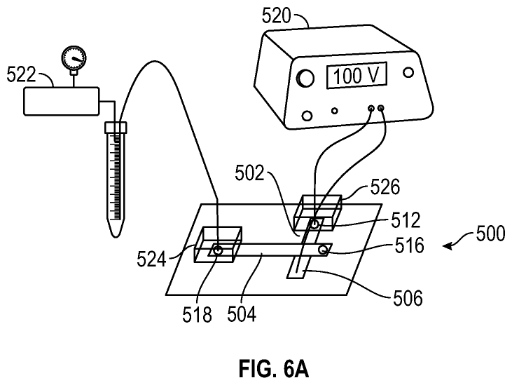

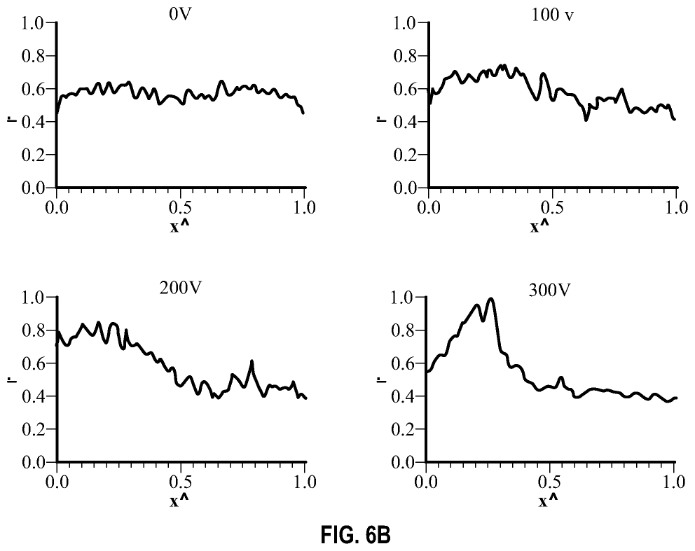

FIG. 6A illustrates μPiP device 500 with a voltage applied thereacross. Voltage was applied via a voltage generator 520 as shown in FIG. 6A. A negatively charged dye (Alexa Flour 594) was used to characterize the electrokinetic system. A solution containing dye and diH₂O was introduced into paper channel 502 via port 518 using a pump 522. Prior to DNA experiments, μPiP device 500 was soaked in 3% w/v BSA (Sigma) in diH₂O for 40 min, followed by washing with diH₂O for 30 min. A DNA solution was then flowed through μPiP device 500 and 1 μL samples were collected from ports 512 and 516 for analysis. Prior to electric field application, port 512 was covered with PDMS slab 524. A needle coupled to generator 520 is embedded in the PDMS slab 524. The needle is positioned to pierce paper channel 504 to serve as a connection point. To induce electrophoresis, a 100 V potential was applied across paper channel 504 for a total of 20 min. After 20 min, the paper in ports 512 and 516 was extracted for quantitative PCR (qPCR) analysis.

To analyze the degree of DNA concentration due to electrophoresis, qPCR was used to track the shift in Cq values, which correspond to a shift in DNA concentration. The no-field samples were diluted 1:100 in diH₂O twice, for a final dilution of 1:10,000. The paper outlets for the 100 V field exposure were also diluted 1:100 twice, for a final dilution of 1:10,000. The qPCR reaction (10 μL final volume) contained 1×qPCR mix (Bio-Rad), 250 nM forward primer (IDT), 250 nM reverse primer (IDT), and 1:10 diluted DNA sample (final dilution of DNA is 1:100,000). The samples that were analyzed by qPCR were 0V: ports 512, 516, 100 V: ports 512, 516, and the original DNA stock, for a total of five samples. Thermal cycler amplifications were cycled between 95° C. for five seconds and 60° C. for thirty seconds, for forty cycles. After amplification, the qPCR data were analyzed using CFX Maestro software (Bio-Rad).

Alexa Flour 594, a negatively charged dye, was used to characterize the electrokinetic system. A solution containing 208 μM dye and DI water was introduced into paper channel 502 at a flowrate of 5 μL/min. When the channel was fully wetted, DC voltage was applied at electrode 506 to deflect dye from bulk solution into paper channel 504. In testing, the rate of deflection increased with an increase in applied voltage. FIG. 6B is a collection of graphs illustrating normalized gray value (I*) versus normalized axial length (X*) at 0V, 100V, 200V, and 300V. At 300 V, all of the dye present in bulk solution was deflected into collection channel. To further visualize dye movement, gray value from a section of the collection channel was measured using ImageJ software. It was also observed that the paper channel—PDMS interface acted as a wall at which dye molecules accumulated. Because of fluid flow and voltage difference, a combination of hydrodynamic and electrokinetic forces pushed the charged dye toward the positive pin of voltage generator 522 at port 512. This dye movement is in agreement with electric field lines generated using COMSOL Multiphysics software.

Nucleic Acid Concentration

An 88 bp, randomly generated, double-stranded DNA sequence was used to separate DNA from a buffer solution. Buffer solution containing 50 nM DNA with trailing electrolyte was flown through paper channel 502 at 5 μL/min 100 V DC voltage was applied to deflect DNA into paper channel 504. After running the operation for 20 min, paper samples were collected from both DNA enriched and depleted channels. The collected DNA was eluted in diH₂O and qPCR was used to evaluate DNA concentration.

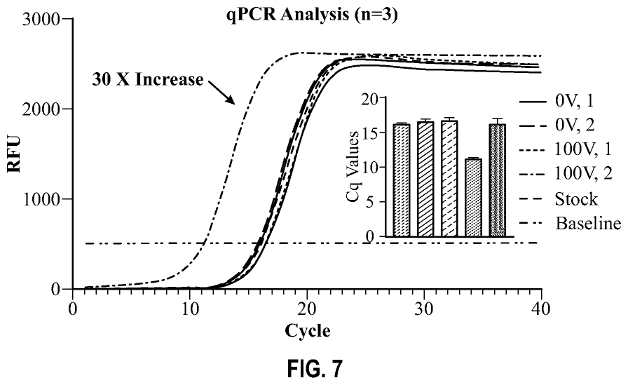

FIG. 7 is a graph of RFU vs Cycles. This qPCR analysis shows a 30-fold increase in DNA concentration as compared to stock solution. This increase in concentration was achieved using only 100 V DC voltage, which can be adapted for use in a portable format. To visualize DNA deflection, a ChemiDoc imaging system was used to measure device fluorescence intensity. As mentioned earlier, SYBR binds with DNA and resulting SYBR-DNA complex which is excited at 497 nm.

Deformability

According to various aspects, μPiP devices maybe be used to study deformability of biological samples. For example, a bovine blood sample was communicated to an inlet of a μPiP device. In testing, the bovine blood sample showed significant flow along a length of the paper channel of the μPiP device. In a second test, a bovine blood sample that had been cross-linked with glutaraldehyde (2%) was communicated to an inlet of a μPiP device at an applied pressure of 1 psi. Glutaraldehyde binds with the membrane proteins of red blood cells (RBCs) and make the red blood cells stiffer. As a result, the red blood cells could not deform and pass through the paper channel of the μPiP device, resulting in significantly less flow compared to the untreated bovine blood sample. This technique can be used to trap diseased cells that cannot deform due to change in membrane protein.

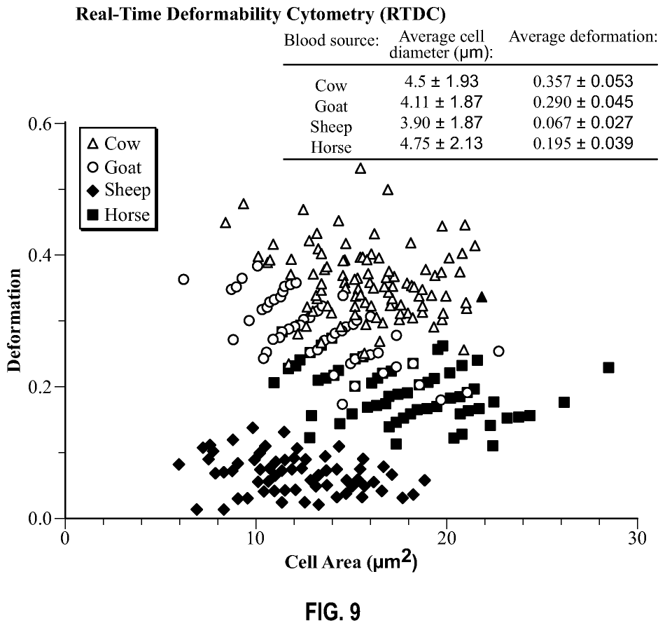

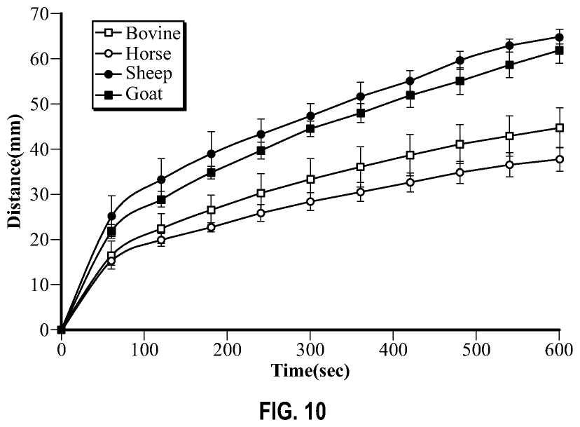

Real-time deformability cytometry (RTDC) was used to examine various animal red blood cells. FIG. 9 is a graph of deformation versus cell area for cow, goat, sheep, and horse blood. Cow blood had an average cell diameter of 4.5±1.93 (μm) and an average deformation of 0.357±0.053; goat blood had an average cell diameter of 4.11±1.87 (μm) and an average deformation of 0.290±0.045; sheep blood had an average cell diameter of 3.90±1.87 (μm) and an average deformation of 0.067±0.027; and horse blood had an average cell diameter of 4.75±2.13 (μm) and an average deformation of 0.195±0.039. A μPiP-based blood deformability test was conducted for various animal red blood cells. FIG. 10 is a graph of distance versus time illustrating wetting length for various animal blood types.

Reuse

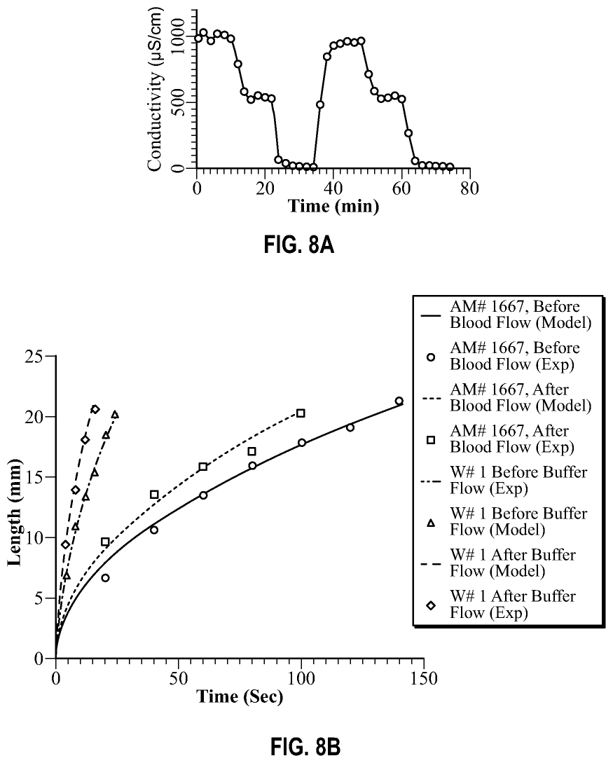

An advantage of μPiP devices is that they can be used multiple times. For example, buffer solutions with different conductivities were introduced at the inlet of a μPiP. A conductivity meter was used to measure outlet buffer conductivity. As shown in FIG. 8A, the outlet buffer conductivity had a step change when the inlet buffer conductivity is changed and the value is similar to inlet conductivity. Therefore, μPiP does not affect the conductivities of buffers and can be used for multiple buffers. After red blood cell flow, the channels were washed with deionized water and dried in a hot plate. Fluid flow characteristics of before and after buffer and blood flow were measured and plotted in FIG. 8B. As shown in FIG. 8B, there was a slight increase in fluid flow rate when the paper channel was used for a second time. This increase in flow rate is due to a slight expansion of paper pores when fluid is flown through them.

Depending on the embodiment, certain acts, events, or functions of any of the processes described herein can be performed in a different sequence, can be added, merged, or left out altogether (e.g., not all described acts or events are necessary for the practice of the processes). Moreover, in certain embodiments, acts or events can be performed concurrently, e.g., through parallel processing, or multiple electron-beam processors rather than sequentially. Although certain steps in the process are described as being performed by a particular device, other embodiments are possible in which these tasks are performed by a different device.

The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” “generally,” and “about” may be substituted with “within [a percentage] of” what is specified.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

What is claimed is:

1. A method for producing a microfluidic device, the method comprising:
placing a first paper channel between first and second polydimethylsiloxane (PDMS) sheets;
treating the PDMS sheets with a corona plasma treater to adhere the PDMS sheets together; and
using heat to laminate the microfluidic device.

2. The method of claim 1, further comprising forming a port through the first PDMS sheet, wherein the port is positioned to overlap with at least a portion of the first paper channel.

3. The method of claim 1, further comprising placing a second paper channel between the first and second PDMS sheets.

4. The method of claim 3, wherein:
the first paper channel comprises a first pore size; and
the second paper channel comprise as second pore size that is smaller than the first pore size.

5. The method of claim 1, wherein the first paper channel is a serpentine channel.

6. The method of claim 1, wherein the first paper channel is gradient channel comprising a plurality of serpentine shaped channels.

7. The method of claim 1, wherein the first paper channel is a Y-shaped channel.

8. The method of claim 1, wherein the first paper channel is an H-shaped channel.

9. The method of claim 1, wherein the first paper channel is water soluble.

10. The method of claim 1, further comprising placing an electrode between the first and second PDMS sheets.

11. A microfluidic device comprising:
a first paper channel; and
first and second polydimethylsiloxane (PDMS) sheets positioned on either side of the first paper channel,
wherein the first and second PDMS sheets are adhered together from a corona treatment.

12. The microfluidic device of claim 11, wherein the first paper channel has a serpentine channel.

13. The microfluidic device of claim 11, wherein the first paper channel is gradient channel comprising a plurality of serpentine shaped channels.

14. The microfluidic device of claim 11, wherein the first paper channel is a Y-shaped channel.

15. The microfluidic device of claim 11, wherein the first paper channel is an H-shaped channel.

16. The microfluidic device of claim 11, wherein the first paper channel is water soluble.

17. The microfluidic device of claim 11, further comprising a port formed through the first PDMS sheet, wherein the port is positioned to overlap with at least a portion of the first paper channel.

18. The microfluidic device of claim 11, further comprising a second paper channel between the first and second PDMS sheets.

19. The microfluidic device of claim 18, wherein:
the first paper channel comprises a first pore size; and
the second paper channel comprise as second pore size that is smaller than the first pore size.

20. The microfluidic device of claim 10, further comprising an electrode between the first and second PDMS sheets.
